(19) United States
(12) Patent Application Publication
(10) Pub. No.: US 2024/0069321 A1
(43) Pub. Date: Feb. 29, 2024

(54) LIGHT PIPE MICROSCOPE FOR LARGE-SCALE DYNAMIC IMAGING

(71) Applicant: Purdue Research Foundation, West Lafayette, IN (US)

(72) Inventor: Meng Cui, West Lafayette, IN (US)

(73) Assignee: Purdue Research Foundation, West Lafayette, IN (US)

(21) Appl. No.: 18/239,829

(22) Filed: Aug. 30, 2023

Related U.S. Application Data
(60) Provisional application No. 63/402,404, filed on Aug. 30, 2022.

(51) Int. Cl. G02B 21/36; G01N 21/64

(52) U.S. Cl. CPC G02B 21/361; G01N 21/6458; G01N 2201/08

(57) ABSTRACT

An apparatus for large-scale dynamic imaging of a sample is described. The apparatus includes an optical detector, a light guide, a dichroic beam splitter, and a light source. The light guide includes a first portion and a second portion. The second defines a tapered shape such that a first diameter defined by a distal end of the second portion is smaller than a second diameter defined by a proximal end of the second portion. The dichroic beam splitter is positioned between the first portion and the second portion of the light guide. The light source is configured to direct a light beam through an external surface of the dichroic beam splitter. The dichroic beam splitter is configured to direct the light beam toward the second open end of the light guide and transfer the return emitted signal through the light guide to the optical detector.

### CROSS-REFERENCE TO RELATED APPLICATIONS

This application is related to and claims the priority benefit of U.S. Provisional Patent Application No. 63/402,404, entitled “Light Pipe Microscope for Large-Scale Dynamic Imaging,” filed Aug. 30, 2022, the contents of which are hereby incorporated by reference in their entirety into the present disclosure.

### GOVERNMENT SUPPORT CLAUSE

This invention was made with government support under contract number NS118302 awarded by the National Institutes of Health. The government has certain rights in the invention.

### TECHNICAL FIELD

The present application relates to microscopy, and specifically to multi-photon laser scanning microscope systems and methods for large-scale high-throughput imaging coverage across deep-tissue surfaces.

### BACKGROUND

Neurological disorders afflict millions of people across the globe. Of the over four hundred currently identified neurological disorders, most have no cures which can often be attributed to our very limited understanding of how the human brain functions. The brain contains tens of billions of neurons and tens of trillions of synapses. Due to this great complexity, gaining precise knowledge demands innovative imaging tools for the quantitative assessment of neuronal dynamics across multiple spatial scales. Over the past decade, the development of genetic function indicators has broadly enabled cellular resolution imaging of neuronal dynamics in animal brains, which transforms the study and understanding of the neuronal network. For mammalian brain studies, multi-photon microscopy is often preferred for its deep-imaging capabilities. However, a major constraint of multi-photon microscopy systems is the limited spatial scale. As the dynamics of mammalian brains involve coordinated activities spanning multiple regions across both hemispheres, studies with current technologies suffer from limitations akin to the parable of blind men and an elephant. As such, the cumbersome designs of modern microscopes will require fundamental redesigns to overcome their existing spatial scale limitations.

### SUMMARY

Accordingly, described herein are apparatuses, systems, and methods for large-scale dynamic imaging of specimen samples. In one embodiment, a system can include an optical detector, a light guide, a dichroic beam splitter, and a light source. The light guide can include an elongated body configured to transmit light therethrough. The light guide can be formed of a first portion which can include distal and proximal ends, with the proximal end of the first portion being optically coupled with the optical detector. The second portion can include distal and proximal ends, with the distal end of the second portion being configured to receive an emitted signal from the sample. Further, the second portion can define a tapered shape. The dichroic beam splitter can be positioned between the first portion and the second portion of the light guide. The light source can be configured to direct a light beam through an external surface of the dichroic beam splitter, and the dichroic beam splitter can direct the light beam toward the second open end of the light guide. Still further, the dichroic beam splitter can receive a return emitted signal from the second open end of the light guide and transfer the return emitted signal through the light guide to the optical detector. The light guide can be formed of transparent glass. In some embodiments, the first portion of the light guide can be formed as a straight pipe, while in other embodiments it can include a bent portion. The bent portion can further include an optical folding element positioned therein which can direct the emitted signal through the bent portion from the distal end of the first portion toward the proximal end of the first portion. In some embodiments, an absorption-based bandpass filter can be disposed between the light guide and the optical detector.

In still some embodiments, the dichroic beam splitter can include a glass cube dichroic beam splitter defining a square geometric body. Further, the distal end of the first portion of the light guide can include an optical facet having a square geometric body shape sized to optically correlate with the square geometric body of the dichroic beam splitter. Also, the proximal end of the second portion can include an optical facet having a square geometric body shape sized to optically correlate with the square geometric body of the dichroic beam splitter. An optical stop can further be positioned on the external surface of the dichroic beam splitter.

Also described herein is a light guide which can have an elongated body configured to transmit light therethrough, and a cube dichroic beam splitter positioned between the first portion and the second portion of the light guide. The elongated body can include a first portion and a second portion. The distal end of the second portion can be configured to receive an emitted signal from a sample, and the second portion can define a tapered shape. The distal end of the first portion of the light guide can include an optical facet having a square geometric body shape sized to optically correlate with the square geometric body of the dichroic beam splitter, and the proximal end of the second portion can include an optical facet having a square geometric body shape sized to optically correlate with the square geometric body of the dichroic beam splitter.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1 depicts comparative output results using two-photon microscopy (TPM) imaging of a live mouse brain using large-etendue (top row) and conventional (bottom row) TPM systems;

FIG. 2 depicts a schematic view of one exemplary light pipe microscope (LPM);

FIG. 3 depicts a schematic view of a lens body comparison between a refraction-based lens (left) and a total internal reflection (TIR) based LPM with similar signal collection efficiencies;

FIG. 4A depicts an output TPM image with excitation NA 0.22 and high-etendue signal collection, showing TPM imaging at 0.55 mm depth;

FIG. 4B depicts a graphical output diagram showing representative calcium transients from neurons shown in FIG. 4A;

FIG. 4C depicts output images showing regions of interest (ROI) of the image of FIG. 4A;

FIG. 4D depicts a heatmap plot of the calcium responses from the ROIs of FIG. 4C;

FIG. 4E depicts an output TPM image with excitation NA 0.22 and high-etendue signal collection, showing TPM imaging at 0.65 mm depth;

FIG. 4F depicts a graphical output diagram showing representative calcium transients from neurons shown in FIG. 4E;

FIG. 4G depicts output images showing regions of interest (ROI) of the image of FIG. 4E;

FIG. 4H depicts a heatmap plot of the calcium responses from the ROIs of FIG. 4G;

FIG. 4I depicts an output TPM image with excitation NA 0.22, showing TPM imaging at 0.55 mm depth;

FIG. 4J depicts an output TPM image with excitation NA 0.40, showing TPM imaging at 0.55 mm depth;

FIG. 4K depicts an output TPM image with excitation NA 0.22, showing TPM imaging at 0.65 mm depth;

FIG. 4L depicts an output TPM image with excitation NA 0.40, showing TPM imaging at 0.65 mm depth;

FIG. 5 depicts a schematic diagram one of example body of an LPM;

FIG. 6A depicts a plot diagram of the NA profile at the output of one LPM with input NA 1.3 and a 5×5 mm² front facet surface;

FIG. 6B depicts a plot diagram representative of enclosed energy relative to NA for different sized front facet surfaces;

FIG. 7A depicts a plot diagram from experiments on a customized dichroic beam splitter (N-LAK33A), the diagram showing fluorescence transmission with and without a 23.4-degree half-cone angle (HCA) with NA 0.7;

FIG. 7B depicts a plot diagram from experiments on a customized dichroic beam splitter (N-LAK33A), the diagram showing reflectivity for a polarized femtosecond laser;

FIG. 7C depicts a plot diagram from experiments on a customized dichroic beam splitter (N-LAK33A), the diagram showing an angle of incidence (AOI)-dependent phase shift;

FIG. 7D depicts a plot diagram from experiments on a customized dichroic beam splitter (N-LAK33A), the diagram showing group delay dispersion;

FIG. 7E depicts a plot diagram from experiments on a customized dichroic beam splitter (N-LAK33A), the diagram showing an AOI-dependent phase shift induced pupil phase profile;

FIG. 7F depicts a plot diagram from experiments on a customized dichroic beam splitter (N-LAK33A), the diagram showing a residual aberration after the linear slope subtraction;

FIG. 8A depicts a schematic diagram of one exemplary NA 0.22 scan lens;

FIG. 8B depicts a plot diagram of experimental output results from the scan lens of FIG. 8A, showing the RMS wavefront error relative to the radius;

FIG. 9A depicts a schematic diagram of one example LPM;

FIG. 9B depicts a schematic diagram of one example imaging application showing four separate LPM units of FIG. 9A densely positioned adjacent one another to image a mouse brain;

FIG. 10A depicts a graphical plot showing an example of temporally interleaved laser excitation;

FIG. 10B depicts a schematic diagram showing an example of splitting the light pulses in time;

FIG. 10C depicts a schematic diagram showing an example of interleaved excitation for reach region;

FIG. 11A depicts a schematic diagram showing an example array of LPMs having folded light pipes;

FIG. 11B depicts a schematic diagram showing one example of how the combination of the low, high, and low index can avoid leakage;

FIG. 11C depicts a schematic diagram showing one example of how using the same glass for the folding prism mirror can introduce leakage;

FIG. 12 depicts a schematic diagram of a two-dimensional (2D) extension having nine interleaved pulse trains;

FIG. 13 depicts a schematic diagram of another version of a LPM system having one or more glass elements positioned within the front portion of the light pipe, showing several variation of the glass elements;

FIG. 14 depicts a schematic diagram of another version of a LPM system having one or more glass elements positioned within the front portion of the light pipe, showing a immersion liquid within the front portion of the light pipe;

FIG. 15A depicts a schematic diagram of another version of a LPM system having a square body and a 4-element lens design;

FIG. 15B depicts a schematic diagram showing a top view of four LPM units of FIG. 15A densely packed over a specimen for imaging;

FIG. 16 depicts a schematic diagram of another version of a LPM system having an optical stop positioned at the entrance facet of the cube dichroic beam splitter;

FIG. 17A depicts a schematic diagram of a front light pipe aperture design with respect to the imaging FOV, showing a single-LPM configuration;

FIG. 17B depicts a schematic diagram of a front light pipe aperture design with respect to the imaging FOV, showing a double-LPM configuration;

FIG. 17C depicts a schematic diagram of a front light pipe aperture design with respect to the imaging FOV, showing a quadruple-LPM configuration;

FIG. 18A depicts a schematic diagram of one example of an orthogonal beam expansion technique for use with an LPM system, showing a relay system having a 3× achromatic anamorphic prism pair for converting a 6×2 mm² beam into a 10×10 mm² beam;

FIG. 18B depicts a plot diagram showing RMS wavefront error with respect to field angles for the orthogonal beam expansion technique of FIG. 18A;

FIG. 18C depicts a schematic diagram of one example of a prism pair for use with the orthogonal beam expansion technique of FIG. 18A; and

FIG. 19 depicts a schematic diagram of one example of a lower-cost dual-LPM system.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description serve to explain the principles of the technology; it being understood, however, that this technology is not limited to the precise arrangements shown, or the precise experimental arrangements used to arrive at the various graphical results shown in the drawings.

### DETAILED DESCRIPTION OF THE ILLUSTRATED EMBODIMENTS

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

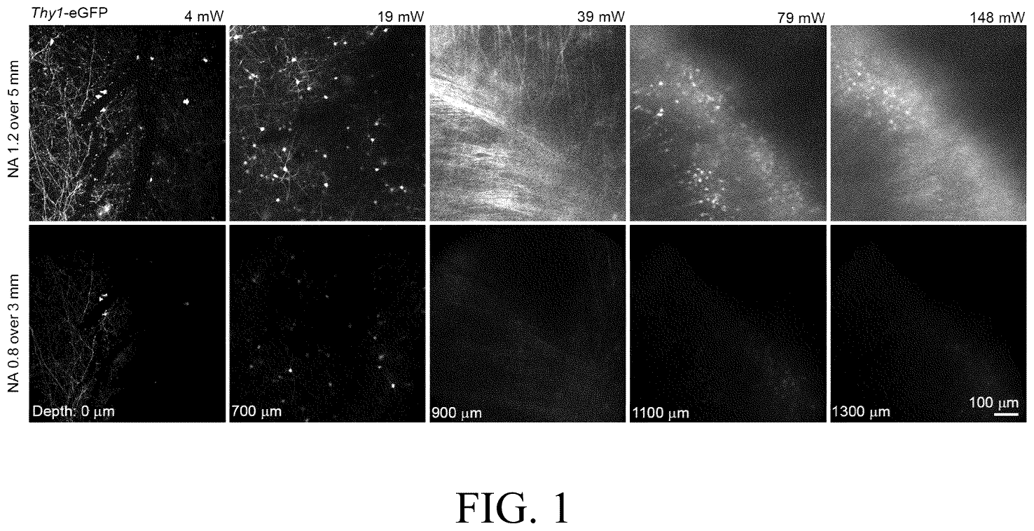

Two-photon fluorescence microscopy (TPM) combined with calcium indication has provided a paradigm shift in neuroscience. Neuroscience has since entered an accelerating phase of discoveries. Compared to camera-based wide-field microscopy, TPM offers superior performance for deep tissue imaging. The mammalian tissue is heterogeneous in refractive index, which introduces spatially and temporally random light scattering. For wide-field imaging, only the ballistic components carry information, which decay exponentially as a function of depth. The scattered light leads to background and noise. Therefore, at large depths, the fluorescence usage efficiency diminishes and carries little information while the majority contributes to a deteriorating signal-to-noise ratio (SNR). In comparison, TPM offers improved fluorescence usage efficiency even at large depths. With sequential scanning and the nonlinearity induced 3D confined excitation, both the ballistic and the scattered emission can be collected to represent the information content at the excitation location. With well-engineered signal collection optics, one can gain superior image quality and depth. For example, as shown in the results of FIG. 1, using a custom-designed large objective lens with a 5 mm field of view (FOV) and a signal collection numerical aperture (NA) of 1.2, large relay optics and PMT detectors, one can significantly outperform the conventional TPM system based on the common 16×NA 0.8 objective lens although both systems used the same excitation parameters. At 1.3 mm depth in a mouse brain, the large-etendue system can still resolve cells. This comparison highlights the advantage and importance of high-NA large-FOV signal collection for deep brain imaging.

However, the implementation of such signal collection methods comes with a drawback: the imaging hardware (e.g., the objective lens and replay optics) occupies two to three orders of magnitude greater area than its imaging area. Therefore, modern TPM systems cannot simultaneously image over a large spatial scale. Even if an array of TPMs were used, the percentage of tissue coverage remains relatively small due to the space constraint. Although miniature imaging optics have been explored for dual-region imaging, their imaging performance is inferior to that enabled by large-etendue detection. Moreover, the tissue area coverage remains low. Another challenge towards whole-neocortex coverage two-photon imaging is that the mammalian brain features a curved surface while modern TPM is often designed to image a planar surface. Therefore, even if a super-sized TPM can be engineered, it remains impractical for imaging over the entire tissue (e.g., mammalian brain) surface. As the dynamics of mammalian brains involve coordinated activities spanning multiple regions across both hemispheres, studies with current technologies suffer from these spatial limitations.

As such, described herein is an improved architecture for multi-photon microscopes, referred to herein as light pipe microscopes (LPMs). LPMs enable a densely packed imaging array for large-scale high-throughput seamless imaging coverage over the entire curved brain surfaces while providing an unparalleled signal collection efficiency. LPMs profoundly transform the study of the brain and other complex biological systems over unprecedented large spatial scales.

The imaging comparison shown in FIG. 1 illustrates that efficient signal collection holds the key to high-performance deep tissue imaging. In existing systems, signal collection is accomplished through custom-made large-size objective lenses. A fundamental difficulty is that modern microscope lenses are based on optical refraction. To collect light with high numerical aperture (NA) over a large area, the refractive element is typically large in size. The LPM described herein abandons the refraction-based light collection and instead relies on total internal reflection (TIR) to collect light at high efficiency with an extremely compact body.

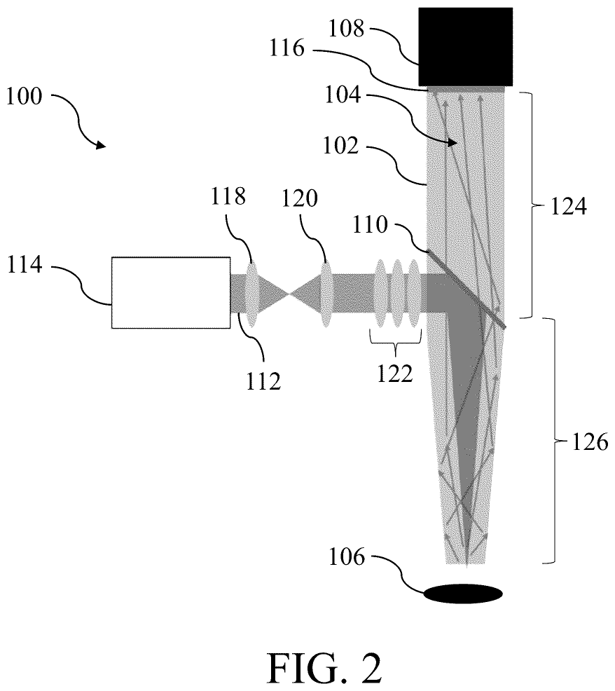

FIG. 2 shows one example of a LPM (100). The main body (102) of the LPM (100) is formed as a glass cylinder or pipe (the “light pipe”) defining an open cavity (104) therethrough. At one end of the main body (102), opposite to the positioning of the specimen (106), is a detector (108), such as a photomultiplier tube (PMT). At a central position within the main body (102), defined as any area between the detector (108) and the specimen (106), is a dichroic beam splitter (110) configured to accept a light signal (112) from a position exterior to the main body (102). The light signal (112) may be generated by a light source (114), such as a laser scanner.

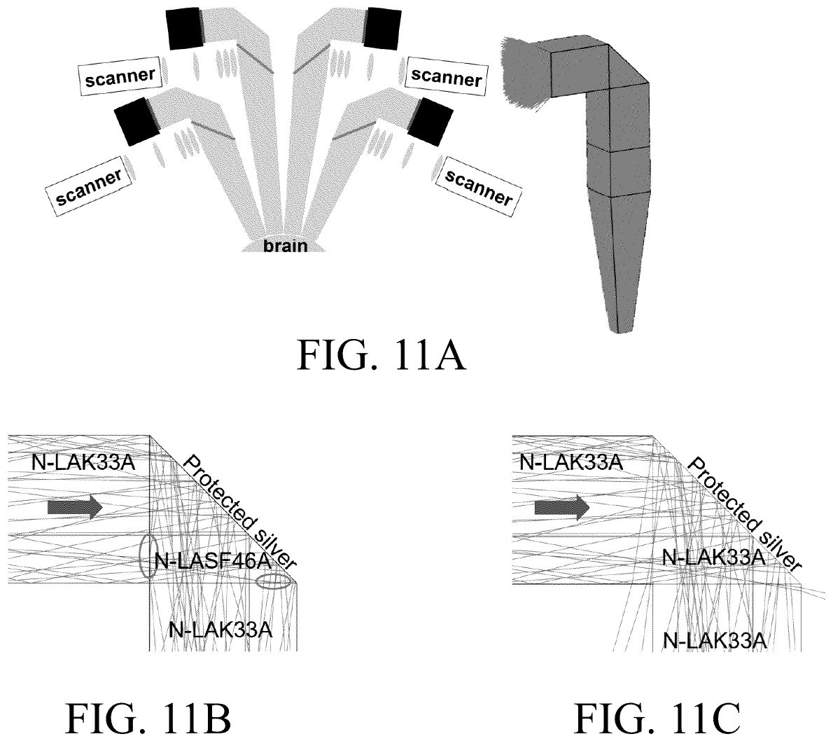

Further, the main body (102) includes a first portion (124) optically coupled with the detector (108) at one end, and optically coupled with a second portion (126) at the opposing end. The second portion (126) is therefore configured to receive an emitted signal from the specimen (106). The second portion (126) defines a tapered internal diameter which is wider at its connection point with the first portion (124) compared to the end positioned adjacent the specimen (106). The first portion (124) can be formed with a constant internal diameter, as shown in FIG. 2, or may include a tapered and/or bent (see, FIG. 11A) shape to direct light signals therethrough once received from the second portion (126). More particularly, the light pipe (102) couples fluorescence emission from the tissue surface of the specimen (106) to the detector (108). The light pipe is composed of three general regions: the front tapered glass (i.e., the second portion (126)), the cube dichroic beam splitter (110), and the straight extension glass (i.e., the first potion (124)) connected to the detector (108).

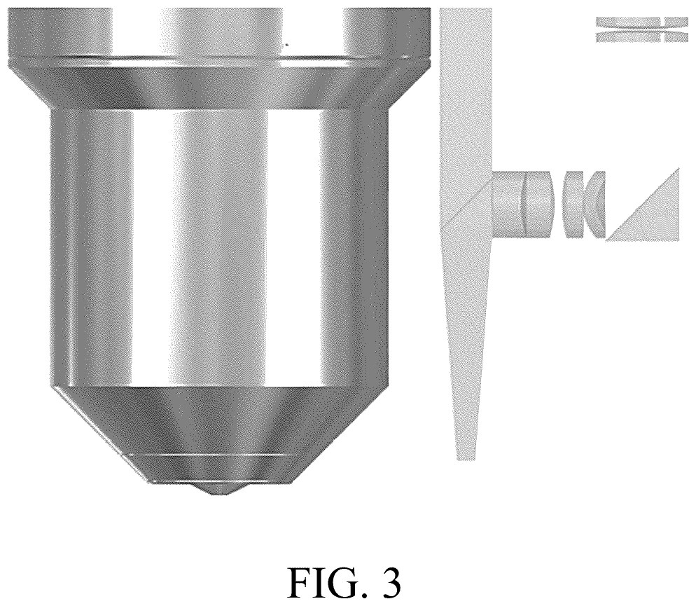

In one example, using N-LASF46A glass manufactured by SCHOTT North America, Inc. of Rye Brooke, NY, for the main body (102), the refractive index is around 1.916 at 520 nm. With water immersion for in vivo imaging, TIR can guide light with a NA up to 1.33 traveling in the glass. Even with a 4×4 mm² anti-reflection coated front surface, its signal collection etendue can match that of the larger lens (NA 1.2 over 5 mm diameter) as used to obtain the results of FIG. 1 while its body volume is ˜1% of that of the larger lens. This lens comparison is shown in FIG. 3. Through the dichroic beam splitter (110), such as a glass cube dichroic beam splitter, a femtosecond light beam can be delivered at 930 nm for two-photon excitation. An absorption-based bandpass filter (116), such as a BG40 manufactured by SCHOTT North America, Inc. of Rye Brooke, NY can be bonded between the main body (102) and the detector (108) by index-matching optical adhesive. In some embodiments, the light beam (112) can be configured to pass through one or more relay lenses (118, 120) and scan lenses (122) before reaching the main body (102).

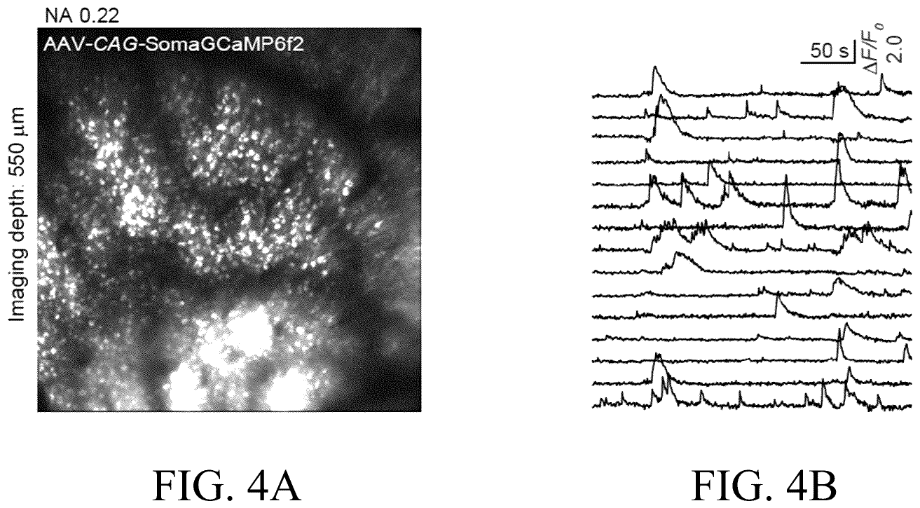

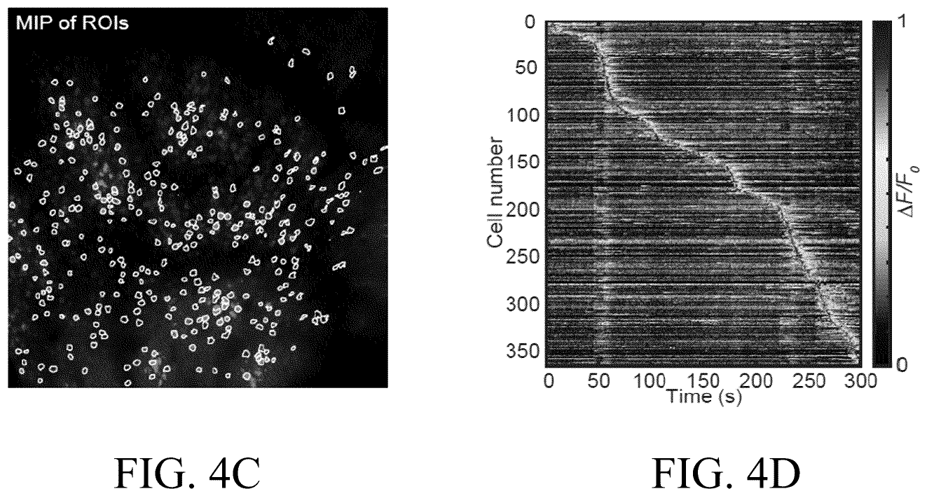

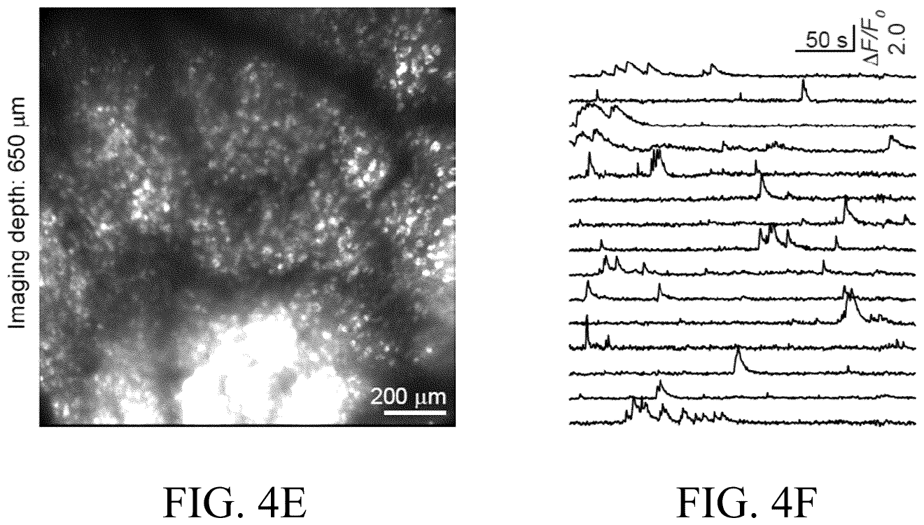

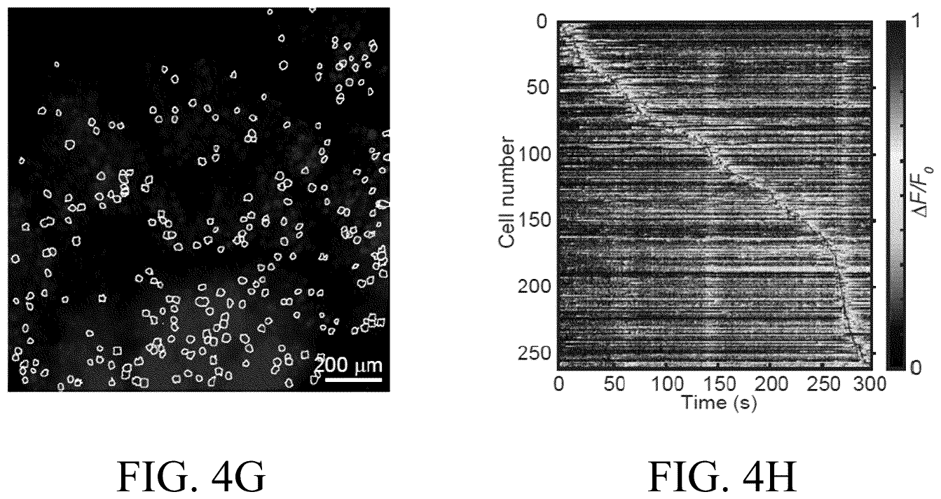

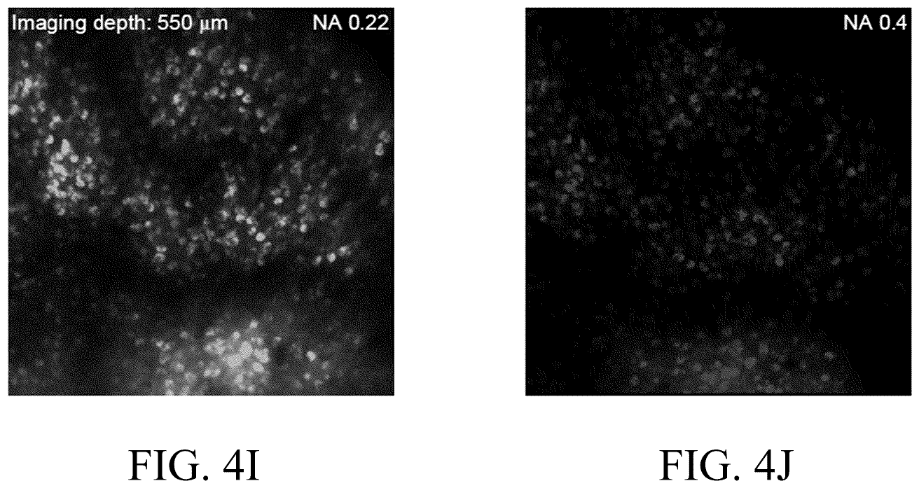

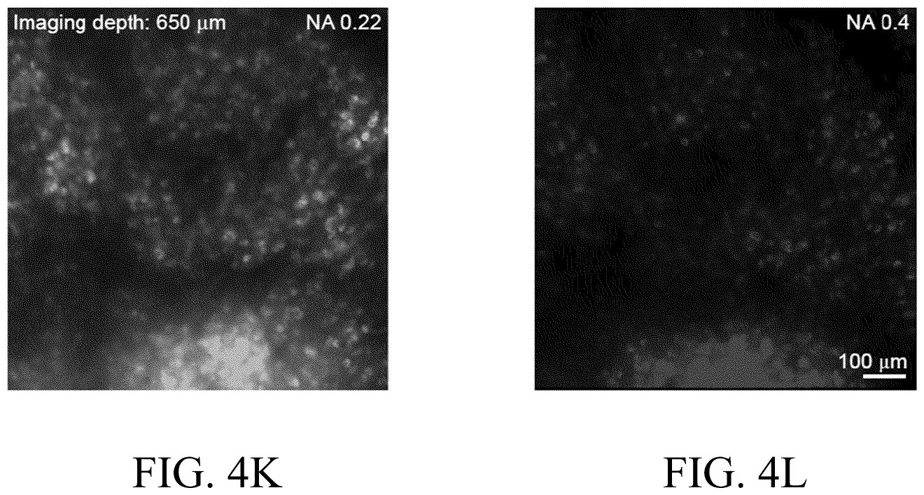

The design of the main body (102) glass dimension depends on the desired excitation NA. To evaluate the required excitation NA, the large objective lens was deployed to mimic the LPM (as they have similar signal collection capability) for calcium imaging with different laser beam diameters at the lens pupil. With an excitation NA 0.22 at 930 nm (1.6 μm and 31 μm in transverse and axial resolutions, respectively), one can achieve cellular resolution calcium imaging deep in the mouse brain (see, FIGS. 4A-4L). Although the axial excitation profile covers about three layers of cells and the neuropil-induced background is higher, the achieved SNR is sufficient for calcium recording. The benefit is that the imaging becomes much less sensitive to the axial tissue motion, which is particularly important for behaving animal studies, especially in large animal models. In addition, more information content (e.g., three layers of cells) can be captured simultaneously within a single image frame. A prototype LPM was developed based on the NA 0.22 excitation.

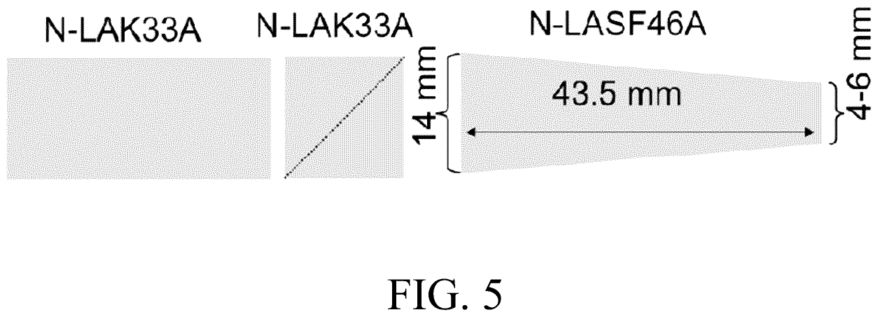

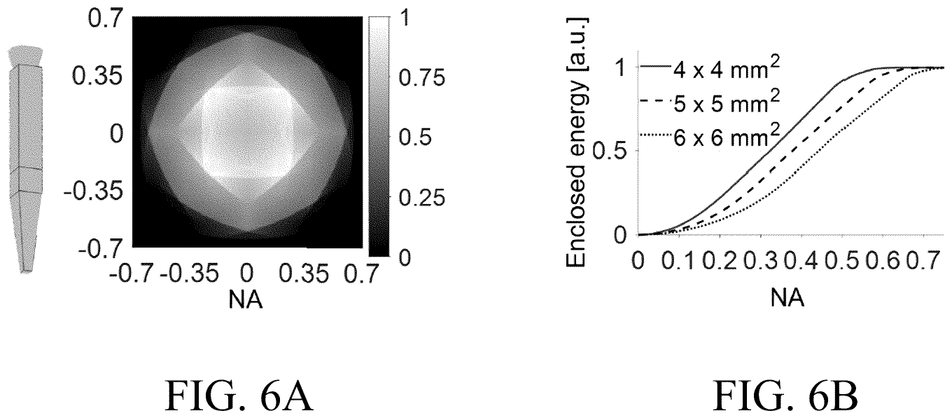

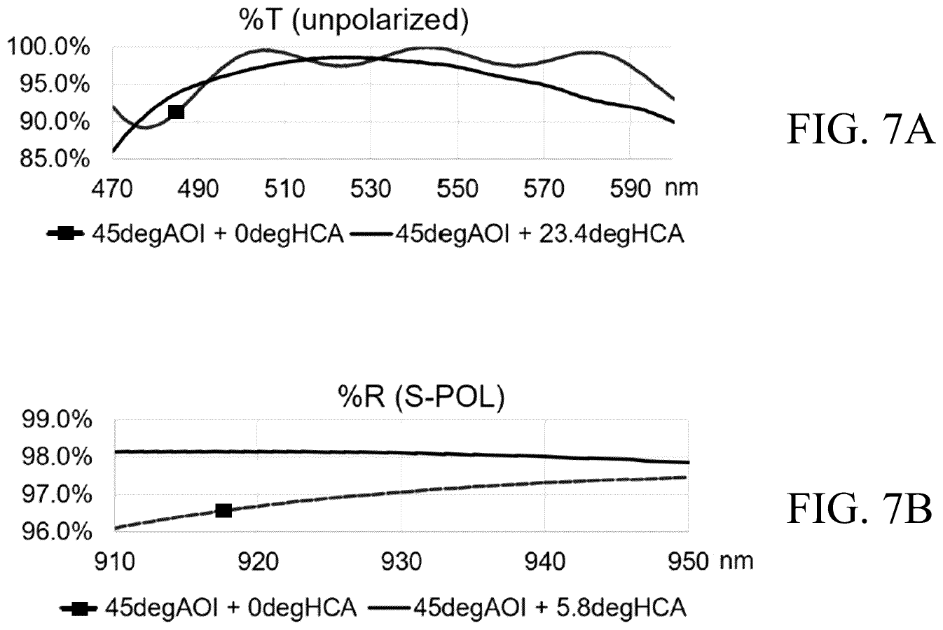

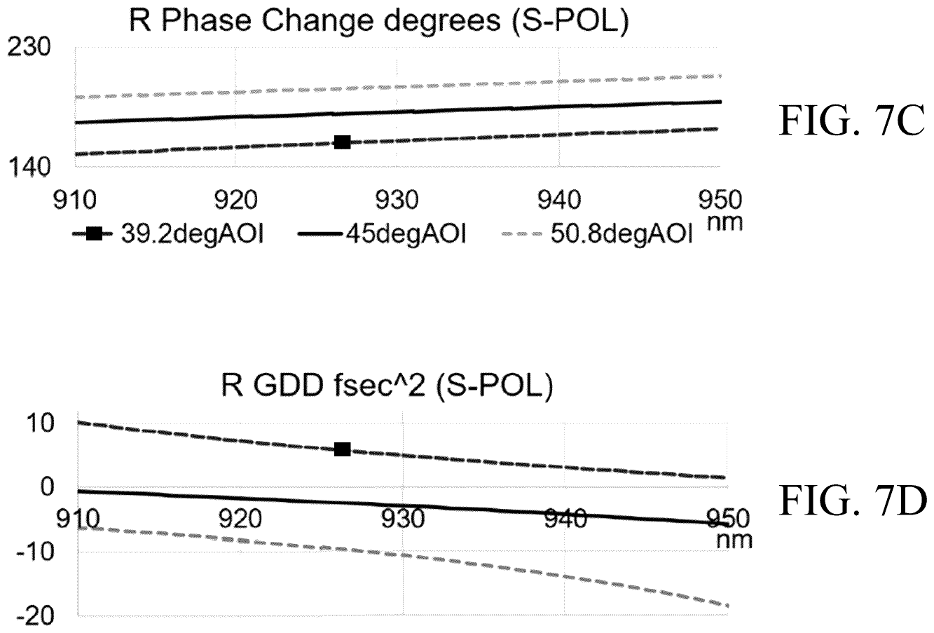

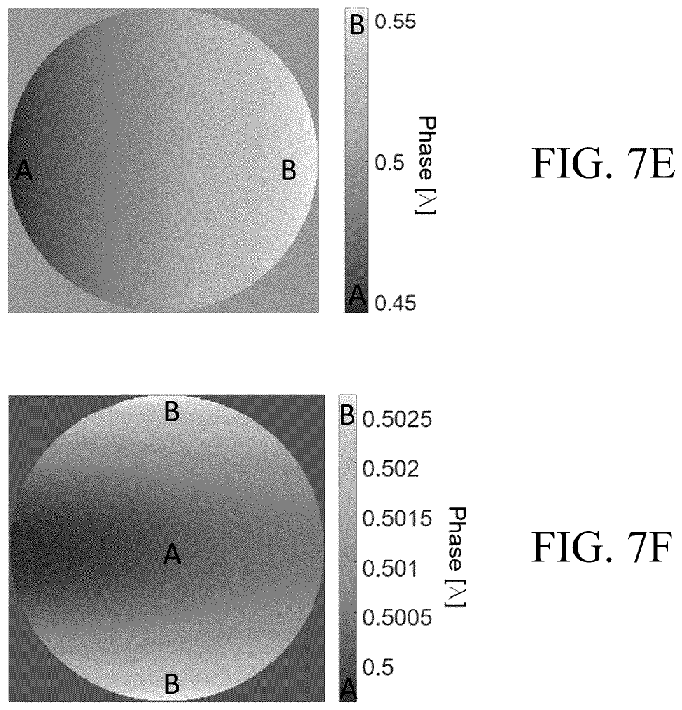

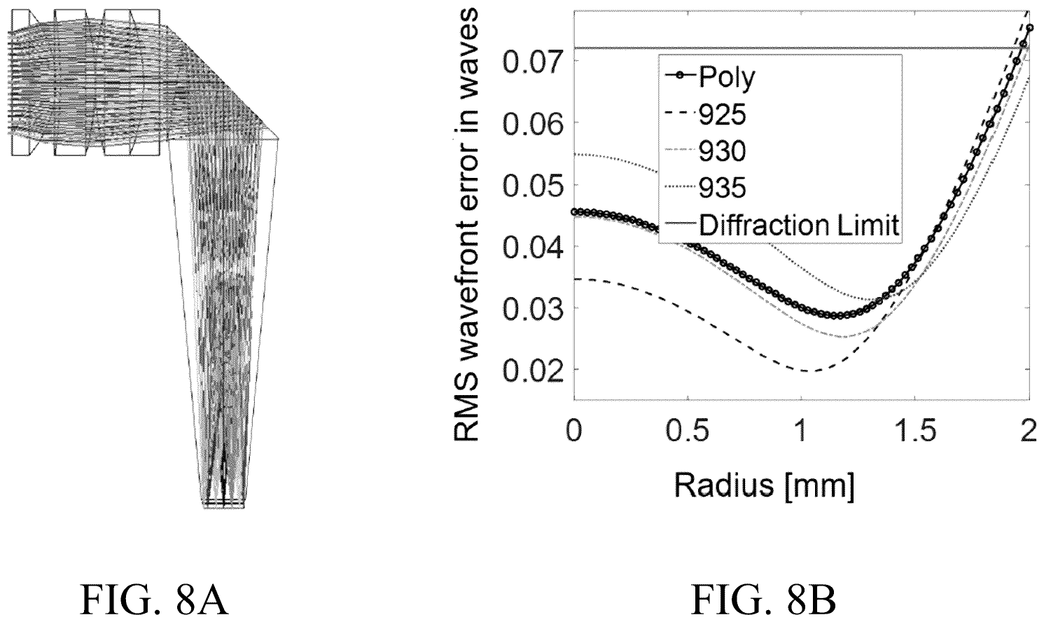

In the experimental example, the second portion (126) (i.e., the tapered portion of the main body (102)) is N-LASF46A glass for its higher index, and the cube dichroic beam splitter (110) and the first portion (124) (i.e., straight extension) glasses are made of N-LAK33A for better compatibility with the dichroic coating and lossless performance in folded pipe design, as shown in FIG. 5. The tapered glass serves two main functions: firstly to better match the size of large detectors, and secondly because the reflection on tapered surfaces can gradually change the direction of the light traveling inside. Using ray-tracing simulation (e.g., Zemax), the NA at the 14 mm end of the tapered glass was evaluated (see, the output results of FIGS. 6A-6B), which show that the tapered light pipe (126) effectively reduced the NA from 1.3 to ˜0.7 while the cross-section was increased to 14×14 mm². Through the subsequent straight pipe (124), the NA is conserved. In some embodiments, a customized cube dichroic beam splitter that can better support the fluorescence emission with NA 0.7 traveling in N-LAK33A glass was used, shown by the studied output diagrams of FIGS. 7A-7D. These studies suggest that each LPM can support signal collection NA 1.3 over up to 6×6 mm² area. For the femtosecond light beam, in addition to the requirement of low group delay dispersion, it is also important to have a slowly varying AOI-dependent phase variation (see, FIG. 7C), as the femtosecond beam is focused (i.e., not collimated). The customized dichroic features a near linear phase variation. With the linear phase slope (non-aberration) removed (see, FIG. 7F), the residual aberration is only ˜3% of lambda. A four-element scan lens, as shown in FIG. 8A, can be included to support 4 mm FOV with NA 0.22 excitation. The pupil was positioned on the dichroic beam splitter so that the scanning did not increase the beam size on the beam splitter to achieve a slim body. The output results are shown in FIG. 8B.

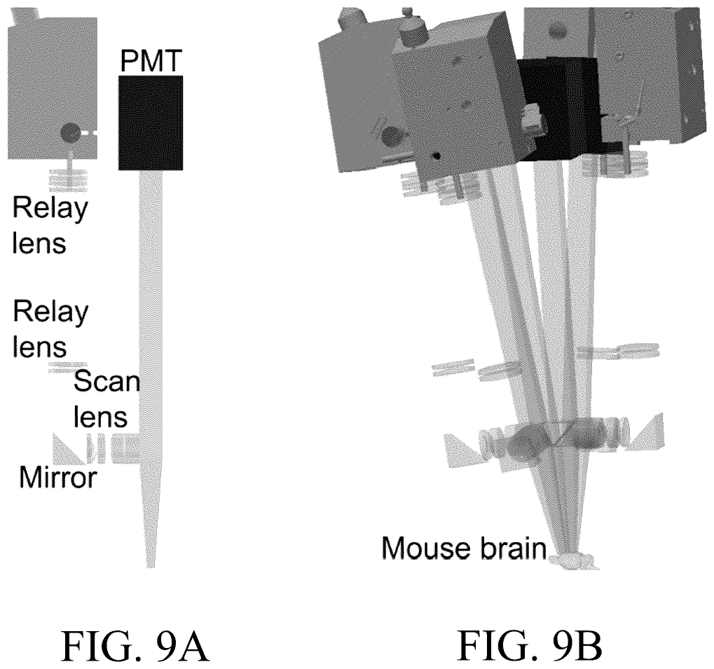

For imaging a curved neocortex, as shown in FIGS. 9A-9B, a plurality of LPMs can be positioned having unique orientations (e.g., perpendicular to the specimen surface or varying degrees therefrom), which can allow the front ends to be densely packed close together even with each tapered glass body (see, FIG. 9B). With elongated glass bodies extending a distance from the detector(s) to the specimen, sufficient space clearance between the detector(s) may be obtained.

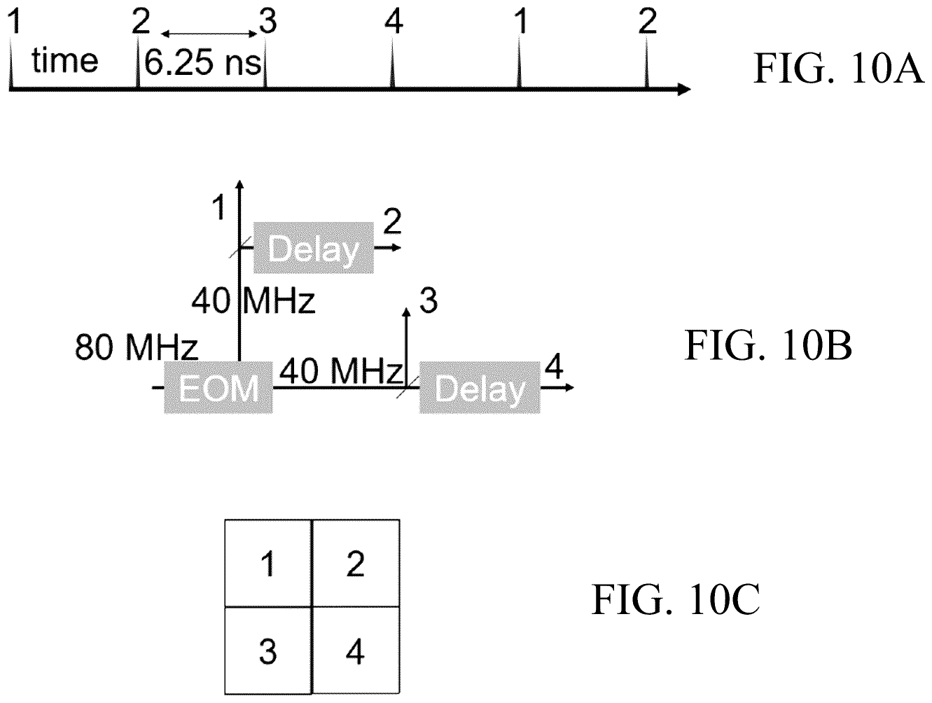

In one example experiment, LPM arrays were configured for two applications. One application was to simultaneously image several isolated regions. The front surface was configured to be slightly larger (e.g., 5×5 or 6×6) than the 4×4 mm² imaging FOV so that the outer FOV can enjoy greater signal collection. With the isolated regions, the crosstalk (i.e., the signal excited by one LPM collected by the other) is small and each LPM runs independently. The other application is to achieve seamless coverage, for which the front surface was configured to be the same size as the FOV. With the dense packing, one advantage is that the signal collection becomes even more efficient. For example, with a 2×2 array, the configuration as shown in FIGS. 10A-10C, the fluorescence excited near the boundary can be collected by neighboring LPMs, extending the signal collection to 8×8 mm². To eliminate the crosstalk, one can employ the interleaved pulse trains for each region. For example, using electro-optical modulators driven by resonant tank circuits, one can split the 80 MHz pulse train into two 40 MHz pulse trains, then use beam splitters and delay lines to create four 40 MHz pulse trains with 6.25 ns gap. These beams are coupled via high-power hollow-core fibers to each LPM.

In one variation, to accommodate more LPM arrays on the specimen, a bent or folding pipe configuration can be configured as shown in FIGS. 11A-11C. LPMs of different heights can be configured so that they can be positioned close together near the specimen with space clearance such that they are all simultaneously operable to image respective portions of the specimen. With NA 0.7 inside the light pipe, common prism mirror designs can induce leakage. Thus, a combination of low, high, and low index glasses can be configured to avoid leakage.

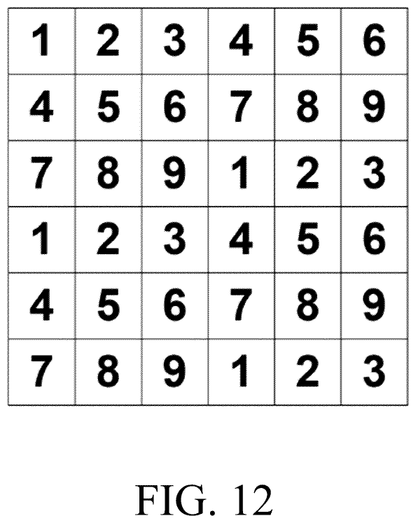

For seamless imaging, a plurality of interleaved pulse trains, such as nine pulse trains, may be utilized (e.g., 20 MHz, 5.56 ns spacing), as shown in FIG. 12. The spatial arrangement of them can form infinite 2D expansion without crosstalk and ambiguity as its eight neighbors in this example can always be unique. Another possibility is to employ hexagon-shaped light pipes to form a hexagon lattice, which will reduce the number of pulse trains from nine to seven. If a single oscillator cannot power all light beams, more than one laser can be deployed, and their pulse trains synchronized.

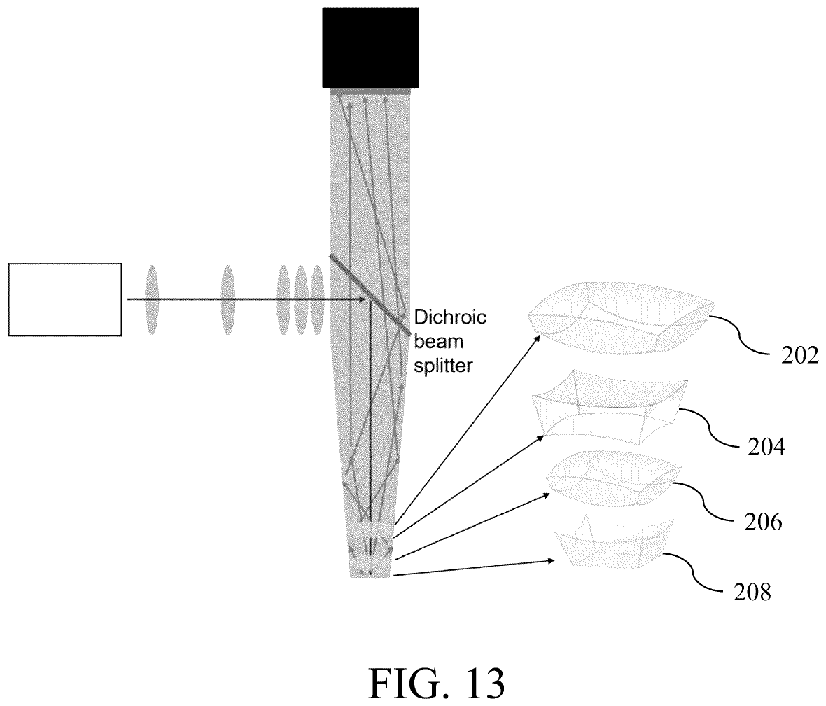

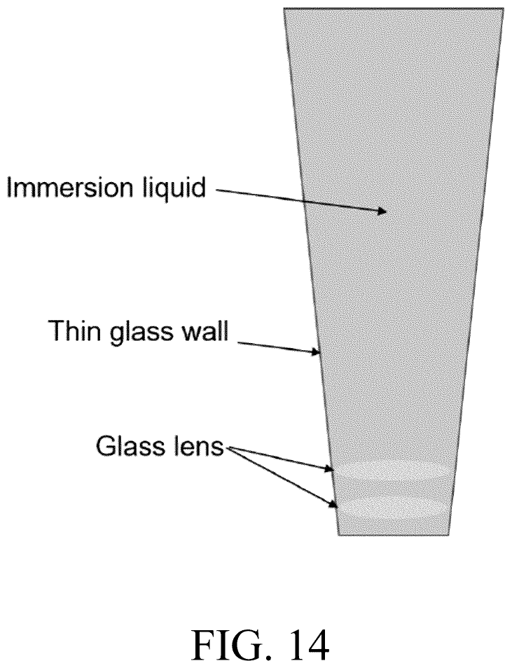

For applications that demand higher spatial resolutions, one can embed optical focusing elements within the front tapered light pipe to achieve higher excitation NA. One method is to form the tapered portion of the light pipe with one or more glass lenses (202, 204, 206, and/or 208), as shown in FIG. 13. These lenses (202, 204, 206, 208) all have four flat surfaces on their respective sides to form the boundaries of the light pipes, and they each have a spherical surface on the top and/or bottom. For high NA focusing, glass of higher index can be used for the spherical convex shapes (e.g., as shown in elements 202, 206) and glass of lower index can be used for the spherical concave shapes (e.g., as shown in elements 204, 208). In some embodiments, as shown in FIG. 14, thin glass may be utilized to form the walls of the tapered portion(s) of the light pipe(s) and a liquid may be filled into the thin glassed to define a specific index of refraction for a particular application, as required. The light-focusing glass elements can be positioned near the front of the tapered portion of the light pipe (i.e., closer to the specimen) and immersed in the liquid. The liquid may be, for example, any liquid of high index of refraction.

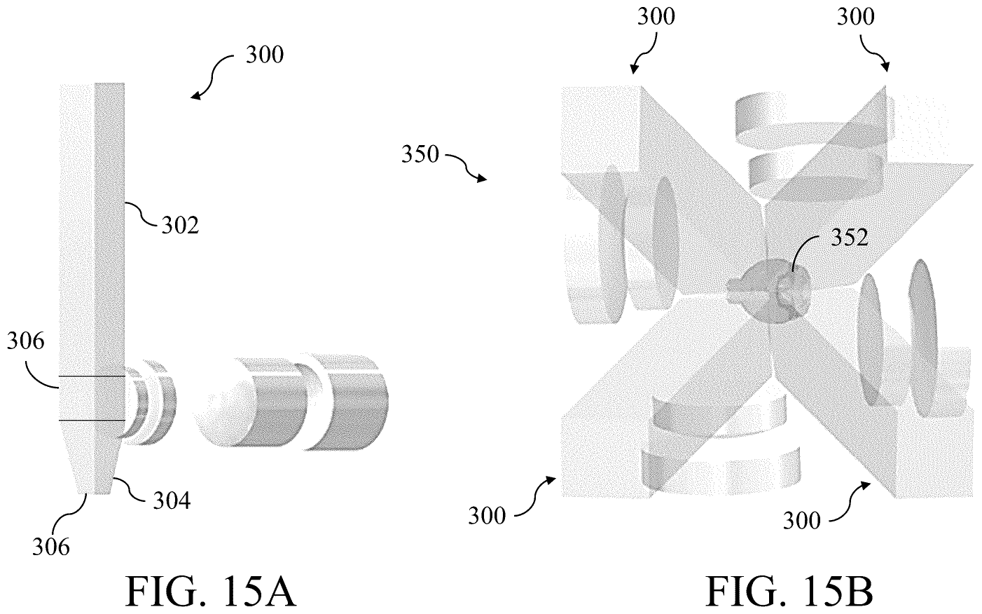

In another variation, a LPM is again composed of three general regions: the straight extension glass (i.e., the first portion), the front tapered glass (i.e., the second portion), and the cube dichroic beam splitter coupled therebetween. For single-cell resolution deep imaging, it was found that the combination of a moderate NA (e.g., 0.4) excitation and ultra-large etendue detection can be highly effective. The benefits of moderate NA excitation are that the beam becomes less sensitive to aberration and axial tissue motion and the energy attenuation of the high incidence angle rays is much reduced. It also simplifies the lens design, significantly reduces the cost, and allows near-seamless positioning of LPMs. Accordingly, as shown in FIGS. 15A-15B, all portions of the LPM (300) can include square-shaped geometries. Particularly, the first portion (302) (i.e., the constant inner diameter portion), the second portion (304) (i.e., the tapered inner diameter portion), and the dichroic beam splitter (306) can form squared inner geometries. As shown in FIG. 15B, multi-LPM applications (350) using squared LPMs (300) each having squared imaging facets (306) permit the LPMs (300) to be more densely positioned near the specimen (352).

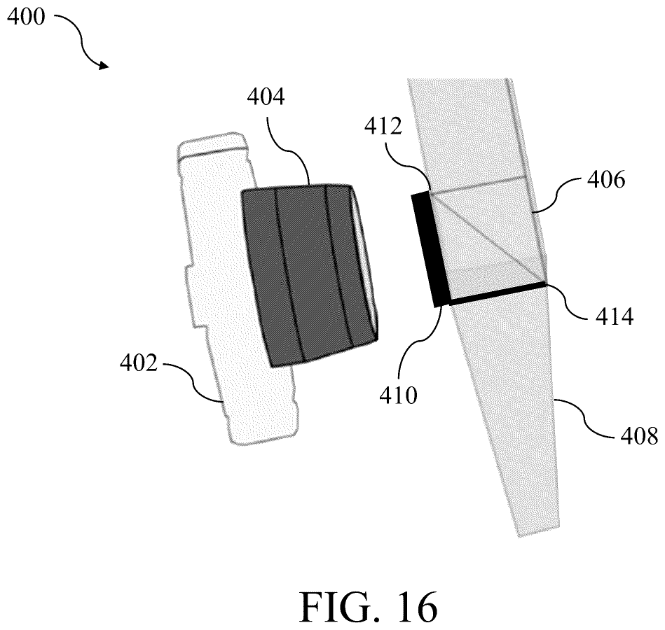

With the shape of the dichroic beam splitter and the field of view (FOV) considered, the squared LPM versions can include the use of a square or rectangular optical stop (410), as shown in FIG. 16, positioned at the light beam entrance facet (412) of the cube dichroic beam splitter. Particularly, FIG. 16 illustrates an LPM system (400) having a piezo stage (402) directing a light beam through an objective (404) toward a cube dichroic beam splitter (406). The light beam is configured to travel through an exterior surface of a portion of a light pipe (408) (i.e., the dichroic beam splitter (406) forming a portion of the light pipe (408)). The square or rectangular optical stop (410) is shaped to match the shape of the entrance facet (412) of the cube dichroic beam splitter (406), fully utilizing the available space to achieve the highest resolution. In some versions, the optical stop (410) can be slightly smaller than the entrance facet (412) of the beam splitter (406). Although the LPM system (400) is illustrated as a simplified system, the optical stop element (410) may be integrated into any of the LPM systems described herein.

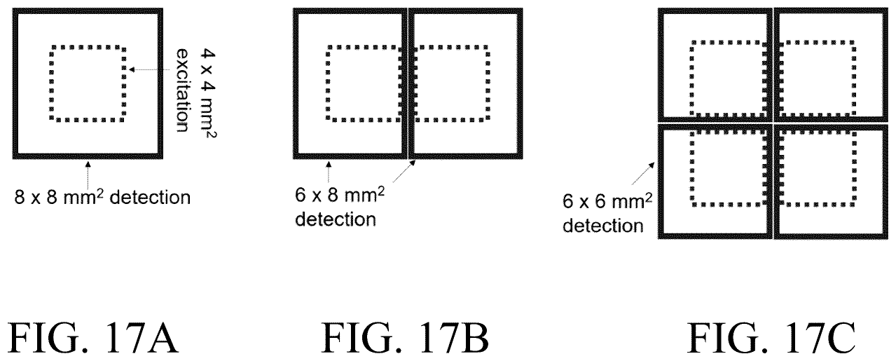

To adapt the system for different imaging tasks, a holder (414) (see, FIG. 16) may be included to attach the second portion (i.e., the tapered portion) of the light pipe to the dichroic cube beam splitter with index-matching oil placed in between the holder and the second portion of the light pipe. A limitation of having the FOV identical to the signal collection area is that the signal collection efficiency varies over the imaging FOV. In particular, the imaging near the outer region of the FOV may have a reduced signal collection support compared to the central region. Accordingly, it can be of great advantage to increase the aperture size further to 8×8 mm² for single-LPM applications, such that there is an additional 2 mm outside the imaging FOV for signal collection. FIGS. 17A-17C illustrate three variations for using one (see, FIG. 17A), two (see, FIG. 17B), and four (see, FIG. 17C) units of LPM in an imaging application. As such, there can always be at least 4×4 mm² collection support around any point (including the points on the corners).

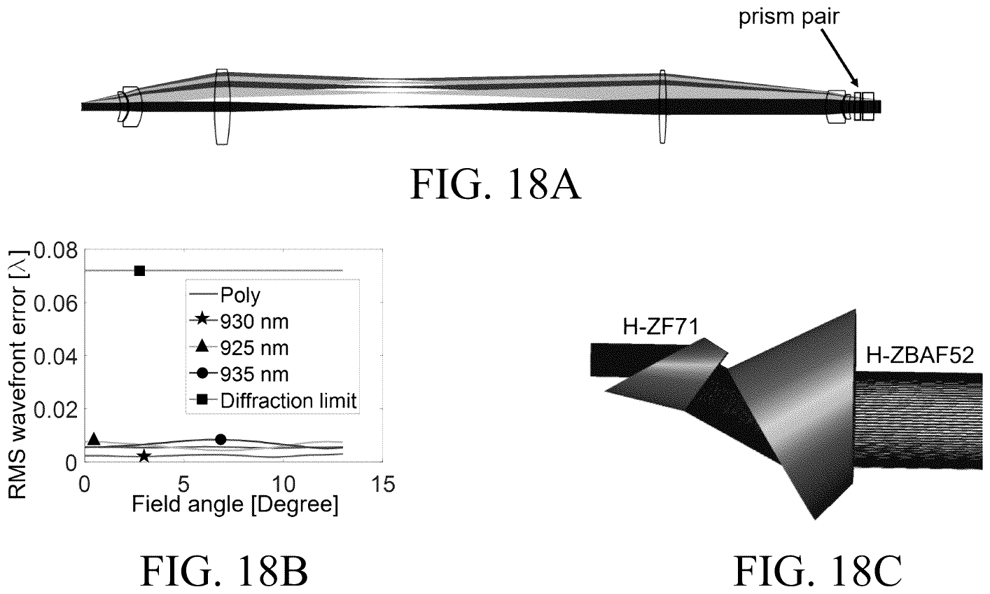

Shown in FIGS. 18A-18C are an orthogonal beam expansion technique which may be integrated into one or more LPM imaging systems. As the common 8 kHz galvanometer sets a limit on the scanning FOV, using the galvanometer at a shallow input angle can support a 6 mm wide by 5 mm tall elliptical shape beam over around 26 optical degrees. To make the beam 6×6 mm² for the square stop of an LPM, an orthogonal beam expansion technique can be utilized. Specifically, the improved configuration sends in a 6 mm wide 2 mm tall laser light beam at a shallow incident angle to the galvanometer and uses an anamorphic prism pair, shown in FIG. 18C, to stretch the beam in the direction orthogonal to the scanning. The prism pair (see, FIG. 18C) adds no aberration to the collimated laser beam. However, for femtosecond beams, it may generate spatial chirp. Based on H-ZF71 and H-ZBAF52 glasses, the 3× achromatic anamorphic prism pair (see, FIG. 18C) can be designed with Brewster input angle to expand the beam to a square shape. The reverse double Gauss-based relay lens design, as shown in FIG. 18A, ensures an aberration-free optical relay over large etendue. This technique can be generalized for mesoscopic TPMs. For example, to achieve large FOV scanning without losing axial resolution, the full aperture of the resonant galvanometer can be equivalent to NA 0.2 and then can expand the beam in the orthogonal direction to NA 0.6. The slow-axis scanner can further support large beams. Thus, the scanning FOV without tiling can be above 5 mm with ˜0.6, 1.8, and 4.3 μm in x, y, and z resolutions, respectively. Overall, the axial resolution may thus be significantly enhanced while obtaining a large FOV and throughput.

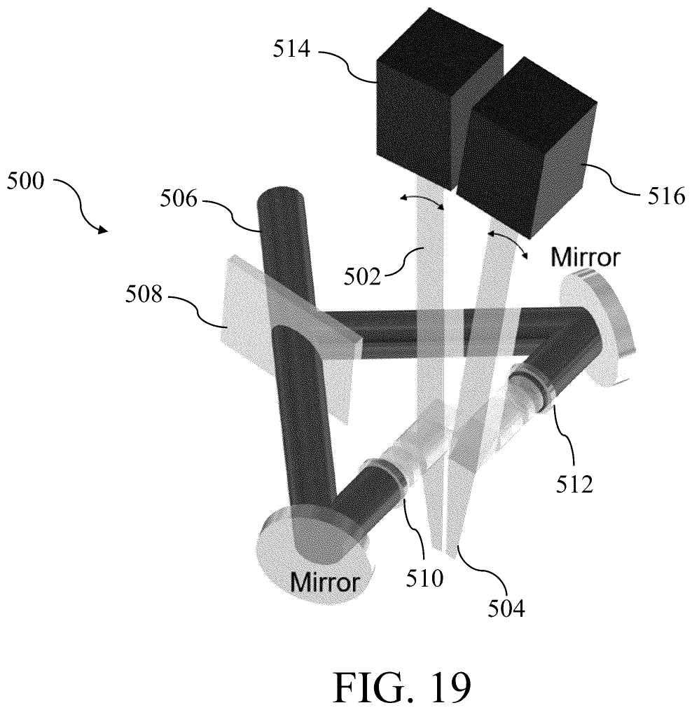

Shown in FIG. 19 is one LPM array configuration (500) which increases the efficiency and cost effectiveness of multi-LPM configurations. The lower-cost dual LPMs (502, 504) may utilize the same input laser source (506) (and thus the same galvanometer scanner, data acquisition system, and software in the user's lab). A beam splitter (508) can be included after the relay lenses to direct separate beams to the LPMs (502, 504) which can be tilted and translated to match the regions of interest and brain curvature. The separation adjustment is achieved by translating the mirror and its associated LPM along the input beam optical axis. The angular adjustment is achieved by tilting the LPM in the plane perpendicular to the optical axis of the input beams. For laser power control, half-wave plates (510, 512) may be positioned before the scan lens. The dichroic may dominantly reflect the S-polarized laser beam. Thus, polarization rotation can provide a simple solution for power control. For applications requiring fast power modulation, one solution is to have two laser light beams, each with an amplitude modulator (e.g. EOM) combine them in orthogonal polarization before they arrive at the galvanometer scanner. A polarizing beam splitter is shown in FIG. 19, which allows for independent and dynamical laser power control. With the two LPMs (502, 504) positioned at the desired locations and angles, the imaging process will be the same as that of the common TPM. The signals from the two detectors (514, 516) can be coupled to two analog input channels, and imaging software can simultaneously record from the two LPMs (502, 504).

Accordingly, as described above, methods of imaging samples can include the LMPs described above. One or more LPMs collects the signal emission(s) from the sample specimen with high NA over a large area and transmits the signal(s) to the detector(s) through the light pipe(s), which form(s) the signal collection system of the multiphoton laser scanning microscope. For each LPM, a dichroic beam splitter is embedded within the glass (e.g., both sides of the reflection surfaces may be positioned in contact with the glass or optical adhesive whose index is similar to the glass). The dichroic beam splitter reflects the femtosecond lasers for signal excitation. The reflected femtosecond beam travels inside the light guide and reaches the sample for signal excitation. The LPM may be composed of three regions: the frontal tapered light pipe, the cube dichroic beam splitter, and the extension glass pipe. In some embodiments, an array of LPMs can be positioned adjacent one another near the specimen to simultaneously image multiple desired regions. In some LPM versions, the LPM includes a folded path, utilizing a higher index for the folding prism mirror (e.g., the index of the folding prism mirror being higher than the light pipes before and after the prism mirror). LPMs can be made of different sizes or heights so that they can be packed together with space clearance. In some LPM versions, to avoid signal crosstalk, interleaved pulse trains may be utilized for each array.

The collective interactions of cells give rise to the function and behavior of biological systems. To understand the function of neuronal networks in specimens such as mammalian brains, it is of paramount importance to observe the dynamics of various types of cells across both hemispheres noninvasively on the brain of behaving animals. With the development of LPMs as described in various embodiments above, a seamless TPM coverage can be obtained of an entire neocortex at cellular resolution. In addition to neuronal dynamics, the vasculature and glial cell dynamics can be recorded, thus forming a comprehensive picture of the entire mammalian neocortex. Beyond mammalian brains, LPMs broadly benefit the in vivo large-scale imaging of complex biological systems. Further, using LPMs, microscopic resolution and macro spatial scale images may be obtained simultaneously for in vivo deep tissue measurement.

Reference systems that may be used herein can refer generally to various directions (for example, upper, lower, forward and rearward), which are merely offered to assist the reader in understanding the various embodiments of the disclosure and are not to be interpreted as limiting. Other reference systems may be used to describe various embodiments, such as those where directions are referenced to the portions of the device, for example, toward or away from a particular element, or in relations to the structure generally (for example, inwardly or outwardly).

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used in combination with some or all of the features of other embodiments as would be understood by one of ordinary skill in the art, whether or not explicitly described as such. One or more exemplary embodiments have been shown and described, and all changes and modifications that come within the spirit of the disclosure are desired to be protected.

I/We claim:

1. An apparatus for large-scale dynamic imaging of a sample, comprising:
(a) an optical detector;
(b) a light guide having an elongated body configured to transmit light therethrough, wherein the elongated body includes:
(i) a first portion including distal and proximal ends, wherein the proximal end of the first portion is optically coupled with the optical detector, and
(ii) a second portion including distal and proximal ends, wherein the distal end of the second portion is configured to receive an emitted signal from the sample, wherein the second portion defines a tapered shape, wherein a first diameter defined by the distal end of the second portion is smaller than a second diameter defined by the proximal end of the second portion;
(c) a dichroic beam splitter positioned between the first portion and the second portion of the light guide;
(d) a light source configured to direct a light beam through an external surface of the dichroic beam splitter, wherein the dichroic beam splitter is configured to direct the light beam toward the second open end of the light guide, wherein the dichroic beam splitter is configured to receive a return emitted signal from the second open end of the light guide and transfer the return emitted signal through the light guide to the optical detector.

2. The apparatus of claim 1, wherein the light guide is formed of transparent glass.

3. The apparatus of claim 1, wherein the first portion of the light guide is formed as a straight pipe.

4. The apparatus of claim 1, wherein the first portion of the light guide includes a bent portion.

5. The apparatus of claim 4, wherein the bent portion includes an optical folding element positioned therein, wherein the optical folding element is configured to direct the emitted signal through the bent portion from the distal end of the first portion toward the proximal end of the first portion.

6. The apparatus of claim 5, wherein the optical folding element includes a prism mirror, wherein a reflecting portion of the prism mirror is coated with a metallic material.

7. The apparatus of claim 6, wherein the metallic material includes silver.

8. The apparatus of claim 6, wherein the prism mirror is comprised of glass, wherein the glass of the prism mirror is of higher index than the first portion of the light guide.

9. The apparatus of claim 1, wherein the light beam includes a femtosecond beam operable for two-photon excitation.

10. The apparatus of claim 1, further comprising:
an absorption-based bandpass filter disposed between the light guide and the optical detector.

11. The apparatus of claim 1, where the dichroic beam splitter includes a glass cube dichroic beam splitter defining a square geometric body.

12. The apparatus of claim 11, wherein the distal end of the first portion of the light guide includes an optical facet having a square geometric body shape sized to optically correlate with the square geometric body of the dichroic beam splitter, and wherein the proximal end of the second portion includes an optical facet having a square geometric body shape sized to optically correlate with the square geometric body of the dichroic beam splitter.

13. The apparatus of claim 11, further comprising an optical stop positioned on the external surface of the dichroic beam splitter, wherein the light source is configured to direct the light beam through the optical stop.

14. The apparatus of claim 1, wherein the second portion of the light guide includes at least one transparent glass lens positioned therein.

15. The apparatus of claim 12, wherein the second portion of the light guide is filled with an immersion liquid.

16. A light guide, comprising:
(a) an elongated body configured to transmit light therethrough, wherein the elongated body includes:
(i) a first portion including distal and proximal ends, and
(ii) a second portion including distal and proximal ends, wherein the distal end of the second portion is configured to receive an emitted signal from a sample, wherein the second portion defines a tapered shape, wherein a first diameter defined by the distal end of the second portion is smaller than a second diameter defined by the proximal end of the second portion;
(b) a cube dichroic beam splitter positioned between the first portion and the second portion of the light guide;
wherein the distal end of the first portion of the light guide includes an optical facet having a square geometric body shape sized to optically correlate with the square geometric body of the dichroic beam splitter, and wherein the proximal end of the second portion includes an optical facet having a square geometric body shape sized to optically correlate with the square geometric body of the dichroic beam splitter.

17. The light guide of claim 16, further comprising an optical stop positioned on an external surface of the dichroic beam splitter.

18. The light guide of claim 16, wherein the second portion of the light guide includes at least one transparent glass lens positioned therein.

19. The light guide of claim 16, wherein the second portion of the light guide is filled with an immersion liquid.

20. An apparatus for large-scale dynamic imaging of a sample, comprising:
(a) an optical detector;
(b) a light guide formed of a transparent glass and having an elongated body configured to transmit light therethrough, wherein the elongated body includes:
(i) a first portion including distal and proximal ends, wherein the proximal end of the first portion is optically coupled with the optical detector, and
(ii) a second portion including distal and proximal ends, wherein the distal end of the second portion is configured to receive an emitted signal from the sample, wherein the second portion defines a tapered shape, wherein a first diameter defined by the distal end of the second portion is smaller than a second diameter defined by the proximal end of the second portion;
(c) a cube dichroic beam splitter positioned between the first portion and the second portion of the light guide; and
(d) an absorption-based bandpass filter disposed between the light guide and the optical detector.
